(19) United States
(12) Patent Application Publication
(10) Pub. No.: US 2015/0318761 A1
(43) Pub. Date: Nov. 5, 2015

(54) MOTOR ARRANGEMENT

(71) Applicants: Andreas KAPPEL, Brunnthal (DE); JOHNSON CONTROLS GMBH, Burscheid (DE)

(72) Inventors: Ingo KIENKE, Wermelskirchen (DE); Rolf SCHÜLER, Heiligenhaus (DE); Gerhard ROTHSTEIN, Velbert (DE); Peter GRUEDL, Jülich (DE)

(21) Appl. No.: 14/654,177

(22) PCT Filed: Dec. 19, 2013
(86) PCT No.: PCT/EP2013/077448

§ 371 Date: Jun. 19, 2015

(30) Foreign Application Priority Data
Dec. 21, 2012 (DE) 10 2012 224 326.7
May 10, 2013 (DE) 10 2013 208 657.1
Aug. 28, 2013 (DE) 10 2013 217 200.1

(51) Int. Cl. H02K 7/116; H02K 7/102; H02K 1/06

(52) U.S. Cl. CPC H02K 7/116; H02K 1/06; H02K 7/102

(57) ABSTRACT

At least one motor arrangement (A1), in particular a planetary gear motor arrangement, including:—a stator (A2) and a rotor (A3) and also a housing (A4) which surrounds the stator and rotor. The stator (A2) is formed from a magnet arrangement (A5) which has a number of solenoids (A6), which are arranged in a ring, and a number of permanent magnets (A7) which is not equal to the number of solenoids (A6). The solenoids and permanent magnets are arranged in relation to one another in such a way that a closed magnetic flux (AF1) with an axial magnetization direction (AR) can be generated in a magnetic field in at least one of the solenoids (A6). An internal rotor (A12), which is provided with an axial external tooth system (A12.1), or a toothed ring as part of the stator (A2) meshes in at least one axial external tooth system (A10.1, A11.1) of the rotor (A3).

### CROSS REFERENCE TO RELATED APPLICATIONS

This application is a United States National Phase Application of International Application PCT/EP2013/077448 filed Dec. 19, 2013 and claims the benefit of priority under 35 U.S.C. §119 of German Patent Application DE 10 2012 224 326.7 filed Dec. 21, 2012, German Patent Application DE 10 2013 208 657.1 filed May 10, 2013 and German Patent Application DE 10 2013 217 200.1 filed Aug. 28, 2013, the entire contents of each application are incorporated herein by reference.

### FIELD OF THE INVENTION

The invention relates to a motor arrangement, in particular a planetary-gear motor arrangement.

### BACKGROUND OF THE INVENTION

Powerful and compact actuating drives, such as planetary gears, in particular swashplate gears with radial or axial runout, are known from the prior art. Here, various designs of the bearing arrangement or suspension by means of toothed gears or ball bearings are known.

A compact drive and a method for operating a drive are known from DE 100 28 964 A1. The compact drive is embodied in such a way that an electric, magnetic and/or electromagnetic field acts on the swashplate in such a way that a torque can be output via the output shaft of the swashplate gear.

### SUMMARY OF THE INVENTION

It is an object of the present invention to specify a motor arrangement, in particular an improved planetary-gear motor arrangement.

It is furthermore an object of the present invention to specify a motor arrangement, in particular a planetary-gear motor arrangement, having an improved suspension.

It is furthermore an object of the present invention to specify a motor arrangement, in particular a planetary-gear motor arrangement, having improved access to the stator.

According to the invention, the object is achieved by means of a motor arrangement, in particular a planetary gear motor arrangement, comprising a stator, in particular a stator situated on the inside, and a rotor assembly, in particular a rotor assembly situated on the outside, and also a housing surrounding said stator and rotor assembly, wherein the stator is formed from a magnet arrangement, which has a number of electromagnets, which are arranged in an annular manner, and a number of permanent magnets which is not equal to the number of electromagnets, said electromagnets and permanent magnets being arranged in relation to one another in such a way that a closed magnetic flux with an axial magnetization direction can be generated in a magnetic field in at least one of the electromagnets, wherein an internal rotor or toothed ring, which is provided with at least one axial external tooth system, meshes in at least one axial external tooth system of the rotor assembly.

In this case, the motor is designed, in particular, as an axial planetary-gear motor. By means of the axial magnetization direction of individual electromagnets, an improved magnetic flux is achieved. The internal rotor performs a spherical wobbling motion which is almost completely free of unbalance, as a result of which noise generation is significantly reduced. A resulting novel axial tooth system of the rotor assembly and stator at at least two locations, also referred to as a double internal wobble tooth system, allows high tooth engagement.

For this purpose, the internal rotor in one possible embodiment is designed in such a way that it meshes at at least two locations on the rotor assembly, in particular diagonally opposite locations. By means of the invention, a particularly compact arrangement is provided with simultaneously improved stability and mobility of the motor arrangement.

In one possible embodiment, the motor has, as an internal rotor, a toothed ring having an inward-curved inner side which is supported on the rotor assembly in a manner which allows axial wobble by means of a wobble bearing, in particular a ball bearing arrangement or a plain bearing or friction bearing arrangement.

As a magnet arrangement, the stator preferably comprises a plurality of electromagnets arranged in an annular manner, which, in particular, are designed as solenoids. In this case, the electromagnet can be designed as a simple electromagnet with an encircling winding. As an alternative, the electromagnet can be provided as a double electromagnet with two magnet halves and two encircling windings, wherein only one of the magnet halves is magnetizable.

A development of the invention envisages that the internal rotor is provided with two axial external tooth systems, which are spaced apart and the teeth of which face away from one another. In corresponding fashion, the rotor assembly comprises two external rotors, which are spaced apart and which are each provided on the mutually facing surface sides with associated axial external tooth systems. In this case, each of the two axial external tooth systems of the internal rotor meshes at just one location in one of the axial external tooth systems of one of the external rotors of the rotor assembly. In particular, the two axial external tooth systems of the internal rotor mesh at diagonally opposite locations in corresponding axial external tooth systems of the external rotors of the rotor assembly.

One possible embodiment envisages that the internal rotor has a U shape in cross section, wherein the legs thereof are oriented radially outward and the electromagnets are arranged in the space between the legs, wherein an axial external tooth system is arranged on the outside of each leg.

The advantages of the motor arrangement according to the invention in the first alternative make possible a better magnetic flux by virtue of the change in the direction of action of the individual magnets from radial to axial. Moreover, the axial internal wobble tooth system, in particular the double internal wobble tooth system, allows high tooth engagement. Doubling the individual magnets furthermore allows an improved, in particular double, energy density (=power relative to required installation space) and improved noise behavior.

According to the invention, the object is furthermore achieved by means of an alternative motor arrangement, in particular a planetary-gear motor arrangement, comprising a stator situated on the outside and a rotor assembly and also a housing surrounding said stator and rotor assembly, wherein the motor arrangement is designed with a single-stage gear and an axial tooth system between a wobble element (also referred to as a compensating or connector element, which performs a wobbling motion in the axial direction (=axial runout)) and an output-side rotor element, in particular a rotor ring.

As regards the alternative motor arrangement, it comprises a motor shaft, a stator, in particular a stator situated on the outside, and a rotor assembly, in particular a rotor assembly situated on the inside, and also a housing surrounding said stator and rotor assembly, wherein the stator is formed from a magnet arrangement, which has a number of electromagnets arranged in an annular manner, and at least one permanent magnet, which are arranged relative to one another in such a way that a closed magnetic flux with an axial magnetization direction in a magnetic field can be generated in at least one of the electromagnets, wherein the motor arrangement is designed with a single-stage gear in such a way that the stator provided with an axial external tooth system or the wobble element meshes in at least one axial external tooth system of the rotor assembly, wherein an at least partially flexible element is arranged on a pinion, between the rotor assembly and the motor shaft, and/or a braking element is arranged on a pinion, between the rotor assembly and the motor shaft.

Compared with a conventional two-stage gear, the motor arrangement according to the invention with a single-stage gear has fewer coupling and tolerance problems in the design of the tooth system due to long tolerance chains, and therefore jamming or incorrect running or failure to run is reduced or prevented. Furthermore, access to the stator and connection to as well as positioning of the electronic controller is improved in the case of the stator according to the invention situated on the outside, as compared with a conventional stator situated on the inside, by virtue of the available installation space. Moreover, the motor arrangement according to the invention is simple to assemble and has a very compact and simple construction with available installation space for a brake against slipping of the motor. The motor arrangement is suitable, particularly by virtue of the compact construction and absorption of high forces, in particular 20 Nm, for use for a backrest adjuster or as a height adjustment motor. As an alternative, it is also possible for the motor arrangement to be designed with a two-stage gear.

A development of the invention envisages that the flexible element is designed in such a way that it is torsionally stiff in the circumferential direction and deformable in the axial direction. In particular, the flexible element serves to compensate for tolerances, in particular assembly and coupling tolerances, between the stator and the rotor assembly. In one possible embodiment, the flexible element is designed as a thin steel plate or a thin steel diaphragm or a corrugated plate.

According to one embodiment, the braking element is designed as a filler piece and/or as a corrugated plate, which is arranged rotatably on the pinion. Moreover, in one possible embodiment, the braking element is designed to be self-locking as an anti-slip brake with interlocking As an alternative, the braking element can be designed in the manner of a slider as an anti-slip brake without interlocking.

Another embodiment of the invention envisages that a wobble element is provided between at least one stator element and a rotor element, wherein the wobble element has at least two tooth systems, which mesh in external tooth systems of the rotor element.

According to the invention, the object is furthermore achieved by means of another alternative motor arrangement, in particular a planetary-gear motor arrangement, comprising
a motor unit having a stator, a rotor assembly, an at least single-stage gear with an axial tooth system between the stator and the rotor assembly, and an integrated electronic controller and
a braking unit at least for braking against slipping of the motor unit,
wherein the motor unit and the braking unit are formed separately and can be coupled to one another.

In other words: the motor arrangement is constructed in a modular manner from the modules comprising the motor unit and the braking unit. Depending on the application, the motor arrangement can be adapted and constructed individually, wherein the motor unit module is formed from the stator, the rotor assembly, the integrated controller (=onboard controller) and with a single- or two-stage gear and the braking unit can be designed in different ways with a constant tooth engagement function, with an anti-slip braking function and/or with a locking function (=“crash lock”).

Moreover, the rotor assembly is designed as a wobble element, which performs a wobbling motion in the axial direction (=axial runout).

An alternative embodiment envisages that the braking unit is embodied in an at least partially integrated way, wherein at least one component, e.g. a braking element, such as a corrugated plate, is part of the motor unit.

As compared with a conventional motor arrangement with an axial gear, the motor arrangement according to the invention can be used for various applications, e.g. as a bicycle drive or as a seat adjuster, in particular a seat back, height or longitudinal adjuster with correspondingly differing requirements, e.g. a decoupling function in the case of a bicycle drive, maintaining engagement without backlash when the motor is stationary, an anti-slip braking function and/or a crash lock in the case of seat adjusters.

The motor arrangement according to the invention having a stator situated on the outside and a rotor assembly situated on the inside improves access to the stator and the connection to and positioning of the electronic controller. Moreover, coupling of braking units of different kinds to the motor unit in the motor arrangement is made possible by virtue of the available installation space. Furthermore, the motor arrangement according to the invention is simple to assemble and has a very compact, simple and modular construction with available installation space for adaptation of the motor arrangement to various applications. Particularly by virtue of the compact construction and absorption of high forces, in particular 20 Nm, and a transmission ratio of, for example, 1:95, the motor arrangement is suitable for use for a seat back adjuster, longitudinal adjuster or height adjuster. As an alternative, it is also possible for the motor arrangement to be designed with a two-stage gear.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. I.1 is a longitudinal sectional view showing schematically a motor arrangement according to the invention;

FIG. I.2 is a longitudinal sectional view showing schematically an embodiment of one half of a motor arrangement according to the invention;

FIG. I.3 is a longitudinal sectional view showing schematically another embodiment of one half of a motor arrangement according to the invention;

FIG. I.4 is a longitudinal sectional view showing schematically yet another embodiment of one half of a motor arrangement according to the invention;

FIG. I.5 is schematic plan view of a motor arrangement in operation and with indication of the magnetic fluxes;

FIG. II.1 is a sectional view showing schematically an illustrative embodiment of a motor arrangement according to the invention having a rotor assembly situated on the inside and a split stator situated on the outside with a single-stage gear and an axial tooth system between a wobble element and a rotor element;

FIG. II.2 is a sectional view showing schematically an alternative illustrative embodiment of a motor arrangement according to the invention with a rotor assembly situated on the inside and a split stator with an axial tooth system between a rotor element having a wobbling motion and the stator;

FIG. II.3 is a sectional view showing schematically two further illustrative embodiments for a motor arrangement according to the invention with a rotor assembly situated on the inside and a simple stator situated on the outside or a split stator which is situated on the outside, having an axial tooth system between a wobbling rotor element and the stator, in each case with an electronic controller which is arranged on the outside and is contactable directly from the outside;

FIG. II.4A is an enlarged sectional view showing schematically a first illustrative embodiment for the region between a rotor ring and a motor shaft with an at least partially flexible element secured between them;

FIG. II.4B is an enlarged sectional view showing schematically a second illustrative embodiment for the region between a rotor ring and a motor shaft with an at least partially flexible element secured between them;

FIG. II.4C is an enlarged sectional view showing schematically a third illustrative embodiment for the region between a rotor ring and a motor shaft with an at least partially flexible element secured between them;

FIG. II.5 is a sectional view showing schematically another illustrative embodiment of a motor arrangement according to the invention having a rotor assembly and a simple stator situated on the outside with an axial tooth system between the stator and the rotor assembly and in each case with an electronic controller which is arranged on the outside and is contactable directly from the outside, and a braking element mounted rotatably on the pinion;

FIG. II.6A is a sectional view showing schematically an illustrative embodiment of a braking element which is mounted rotatably on a pinion and which engages in a corresponding stop contour on the interior of the housing;

FIG. II.6B is a sectional view showing schematically an illustrative embodiment of a braking element which is mounted rotatably on a pinion and which engages in a corresponding stop contour on the interior of the housing;

FIG. II.7 is a sectional view showing schematically another illustrative embodiment of a filler element which is mounted rotatably on a pinion and which runs with a sliding action along the interior of the housing;

FIG. II.8 is an enlarged sectional view showing schematically another illustrative embodiment of a braking element, which engages in a stop contour on the interior of the housing;

FIG. II.9 is an enlarged sectional view showing schematically another illustrative embodiment of a filler element which is mounted rotatably on a pinion and which runs with a sliding action along the interior of the housing;

FIG. II.10 is a sectional view showing schematically another illustrative embodiment of a motor arrangement according to the invention having a rotor assembly and a simple stator situated on the outside and a wobble element arranged between said rotor assembly and stator and having an axial tooth system between the wobble element and the rotor element;

FIG. II.11 is a sectional view showing schematically an illustrative embodiment of a rotor ring of rigid design;

FIG. II.12 is a sectional view showing schematically an illustrative embodiment of a rotor ring of flexible design;

FIG. II.13 is a plan view showing schematically an illustrative embodiment of a rotor ring of flexible design having a plurality of individual segments without an external tooth contour;

FIG. II.14 is a sectional view showing schematically an individual segment with adjoining compensation zones;

FIG. II.15 is a perspective view showing schematically an individual segment;

FIG. II.16 is a sectional view showing schematically an illustrative embodiment of a braking element, which is designed as an integrated actuator;

FIG. II.17A is a sectional view showing schematically an illustrative embodiment of a rotor element having an alternative tooth system contour with partial clearance cuts;

FIG. II.17B is a sectional view showing schematically an illustrative embodiment of a rotor element having an alternative tooth system contour with partial clearance cuts;

FIG. III.1 is an exploded view showing schematically one embodiment of a motor arrangement having an individual module comprising a motor unit but no braking unit;

FIG. III.2 is an exploded view showing schematically another embodiment of a motor arrangement having the module comprising a motor unit and additionally a module comprising a braking unit with a simple anti-slip braking function (corrugated plate) and indirect overload safeguard (crash lock);

FIG. III.3A is a plan view showing schematically an embodiment of a motor arrangement having a braking unit with a simple anti-slip braking function and with an indirect overload safeguard (crash lock);

FIG. III.3B is a plan view showing schematically an embodiment of a motor arrangement having a braking unit with a simple anti-slip braking function and with an indirect overload safeguard (crash lock);

FIG. III.4A is a plan view showing schematically an embodiment of a motor arrangement having a braking unit with a simple anti-slip braking function and with an indirect overload safeguard (crash lock);

FIG. III.4B is a plan view showing schematically an embodiment of a motor arrangement having a braking unit with a simple anti-slip braking function and with an indirect overload safeguard (crash lock);

FIG. III.5 is a plan view showing schematically an embodiment of a motor arrangement having a braking unit with a simple anti-slip braking function and with an indirect overload safeguard (crash lock);

FIG. III.6A is a plan view showing schematically an alternative embodiment of a motor arrangement having a braking unit without an anti-slip braking function and with an alternative overload safeguard (crash lock);

FIG. III.6B is a plan view showing schematically an alternative embodiment of a motor arrangement having a braking unit without an anti-slip braking function and with an alternative overload safeguard (crash lock);

FIG. III.7A is a plan view showing schematically an alternative embodiment of a motor arrangement having a braking unit with an anti-slip braking function and with an alternative overload safeguard (crash lock);

FIG. III.7B is a plan view showing schematically an alternative embodiment of a motor arrangement having a braking unit with an anti-slip braking function and with an alternative overload safeguard (crash lock);

FIG. III.8 is a plan view showing schematically an alternative embodiment of a motor arrangement having a braking unit with an anti-slip braking function and with an alternative overload safeguard (crash lock);

FIG. III.9A is a plan view showing schematically an alternative embodiment of a motor arrangement having a braking unit with an anti-slip braking function and with an alternative overload safeguard (crash lock);

FIG. III.9B is a plan view showing schematically an alternative embodiment of a motor arrangement having a braking unit with an anti-slip braking function and with an alternative overload safeguard (crash lock);

FIG. III.10A is a plan view showing schematically an alternative embodiment of a motor arrangement having a braking unit with an alternative anti-slip braking function and without an overload safeguard (crash lock);

FIG. III.10B is a plan view showing schematically an alternative embodiment of a motor arrangement having a braking unit with an alternative anti-slip braking function and without an overload safeguard (crash lock);

FIG. III.10C is a plan view showing schematically an alternative embodiment of a motor arrangement having a braking unit with an alternative anti-slip braking function and without an overload safeguard (crash lock);

FIG. III.11 is a plan view showing schematically an alternative embodiment of a motor arrangement without an anti-slip braking function and without an overload safeguard (crash lock);

FIG. III.12A is a plan view showing schematically an alternative embodiment of a motor arrangement without an anti-slip braking function and without an overload safeguard (crash lock); and

FIG. III.12B is a plan view showing schematically an alternative embodiment of a motor arrangement without an anti-slip braking function and without an overload safeguard (crash lock).

### DESCRIPTION OF THE PREFERRED EMBODIMENTS

In all the figures, parts which correspond to one another are provided with the same reference signs.

FIG. I.1 shows a motor arrangement A1. In particular, the motor arrangement A1 is embodied as an axial planetary-gear motor arrangement.

The motor arrangement A1 comprises a stator A2 and a rotor assembly A3 and also a housing A4 surrounding said stator and rotor assembly. In this case, the housing A4 can be formed by two housing halves, in particular covers.

A motor shaft A9, which carries the rotor assembly A3, is supported on the stator A2 by means of a wobble bearing A8. As shown by way of example in figure I.1, the wobble bearing A8 can be designed as a ball bearing. As an alternative, the wobble bearing A8 can be designed as a plain bearing or friction bearing. On the input side, the motor shaft A9 is supported on the housing A4 by means of a shaft bearing A13. The shaft bearing A13 is embodied as a roller bearing. As an alternative, it can be embodied as a plain bearing.

The rotor assembly A3 comprises an external rotor A10 on the output side and an external rotor A11 on the input side, each of which has an associated axially inward-facing external tooth system A10.1 and A11.1 respectively.

In the region of the shaft bearing A13, the input-side external rotor A11 is of reinforced design, thereby improving stiffness.

The stator A2 is of annular design and comprises a number of individual segments, each of which is designed as an electromagnet A6. The electromagnets A6 are arranged in an annular manner and are part of a magnet arrangement AS for commutating the motor arrangement A1.

On the one hand, the magnet arrangement A5 comprises the electromagnets A6 arranged in an annular manner and a number of permanent magnets A7 unequal to the number of electromagnets A6.

In this case, the electromagnets A6 and the permanent magnets A7 are arranged relative to one another in such a way that a closed magnetic flux AF1 with an axial magnetization direction AR in a magnetic field can be generated in at least one of the electromagnets A6.

In this case, the permanent magnets A7 are part of an internal rotor A12, which is designed as a toothed ring having an associated axial external tooth system A12.1. In cross section, the internal rotor A12 has a U shape, wherein resulting legs A12.3 are oriented radially outward and the electromagnets A6 are arranged in the space between the two legs A12.3. The legs A12.3 are provided with the external tooth system A12.1 on the outside.

In this case, the axial external tooth system A12.1 of the internal rotor A12 meshes at two locations of an axial external tooth system of the rotor assembly A3, namely, on the one hand, in the axial external tooth system A10.1 of external rotor A10 and, on the other hand, in the axial external tooth system A11.1 of external rotor A11. The resulting novel axial external tooth system of the rotor assembly A3 and the stator A2 at at least two locations is also referred to as a double internal wobble tooth system and, by doubling the tooth systems, allows a high tooth engagement.

Axial external tooth system A12.1 is provided on both outer surface sides of the legs A12.3 and is thus duplicated. In this case, each of the axial external tooth systems A12.1 of the internal rotor A12 meshes in a corresponding axial external tooth system A10.1, A11.1 of one of the external rotors A10 and A11, in particular of the opposite external rotor.

By means of the axial magnetization direction AR of individual electromagnets A6, an improved magnetic flux AF1 is furthermore achieved. In this case, the internal rotor A12 performs an axial circular wobbling motion which is almost completely free of unbalance and thus causes significantly reduced noise.

As shown in FIG. I.1, the internal rotor A12 is designed as a toothed ring or yaw ring having an inward-curved inner side A12.2 which is supported on the rotor assembly A3 by means of the wobble bearing A8 so as to perform an axial wobbling motion.

The internal rotor A12 is designed in such a way that it meshes at at least two locations of the rotor assembly 3, in particular diagonally opposite locations. For this purpose, the internal rotor A12 is provided with two axial external tooth systems A12.1, which are spaced apart and the teeth of which face away from one another. In a corresponding manner, the rotor assembly A3 comprises two external rotors A10, A11, which are spaced apart and are provided on the mutually facing surface side with associated axial external tooth systems A10.1, A11.1.

In one possible embodiment, the internal rotor A12 has a U shape in cross section, wherein the legs A12.3 thereof are oriented radially outward and the electromagnets A6 are arranged in the space between the legs A12.3. An axial external tooth system A12.1 is arranged on the outside of each leg A12.3.

The individual electromagnets A6 of the stator A2 are arranged in an annular manner and are preferably designed as solenoids. In the illustrative embodiment according to FIG. I.1, the respective electromagnet A6 is embodied as a double electromagnet with two magnet halves A6.1 with two encircling windings A6.2. The electromagnets 6 are arranged between the legs A12.3 of the internal rotor A12.

During the commutation of the motor arrangement A1, a magnetic field and hence a magnetic flux AF1 is generated only in one of the magnet halves A6.1 of at least one of the electromagnets A6, wherein the affected leg region of the internal rotor A12 is magnetically attracted in a resulting magnetically active region A14, and the affected leg region and the affected electromagnet A6 make contact with an attenuation layer, in particular an air gap A15, if appropriate.

By virtue of the fact that a magnetic field is generated only in one of the magnet halves A6.1, the closed magnetic flux AF1 is not negatively affected owing to the magnetization direction AR running axially and centrally inward.

As an alternative, a magnetic field AF1 can be generated in each of two of the electromagnets A6, in particular in electromagnets A6 arranged opposite one another. For this purpose, two induction units are provided, which can be synchronized in such a way that magnetic fields and magnetic fluxes AF1 resulting therefrom can be generated simultaneously. Twice the number of electromagnets A6 can thus be active, and twice the energy density is thereby achieved.

The individual electromagnets A6 or the magnet halves A6.1 thereof can furthermore be controlled via a bus.

The electromagnet A6 and thus the magnet halves A6.1 can be composed of a soft-magnetic sintered and powder composite material, a magnetic or magnetizable sheet metal or of a plastic containing soft-magnetic particles.

The internal rotor A12 is designed as a permanent magnet, as shown in FIG. I.1. As an alternative, the internal rotor A12 can be formed by a soft-magnetic sintered and powder composite material, a magnetic or magnetizable sheet metal or of a plastic containing soft-magnetic particles; in this case, the internal rotor A12 additionally comprises permanent magnets A7, which are arranged on the outside or are integrated, these being shown in FIGS. I.3 and I.4.

FIG. I.2 shows another embodiment of a motor arrangement A1 with a permanent magnet 7 integrated into the internal rotor A12.

FIG. I.3 shows an alternative embodiment of a motor arrangement A1 with electromagnets A6 designed as individual magnets and each having an associated winding A6.2.

In the center, the internal rotor A12 has an enlarged inner side A12.2, in which a permanent magnet A7 is integrated. Such centered arrangement of integrated permanent magnets A7 allows a closed magnetic flux AF1 via the housing A4 and the magnetizable internal rotor A12.

FIG. I.4 shows another alternative embodiment of a motor arrangement A1 with electromagnets A6 designed as individual magnets and each having an associated winding A6.2.

In this arrangement, the internal rotor A12 or yaw ring is integrated into a cavity in the region of the motor shaft A9.

In this illustrative embodiment, the internal rotor A12 is embodied as a ring, on which a plurality of permanent magnets A7 oriented radially outward is arranged. On its axial ends, the internal rotor A12 in the form of a circular ring has the axial external tooth system A12.1, which engages in the axial external tooth system A10.1 or A11.1 of the rotor assembly A3. A strong closed magnetic flux AF1 is thereby obtained.

This motor arrangement A1 preferably has twelve electromagnets A6 arranged in an annular manner and fourteen permanent magnets A7, likewise arranged in an annular manner on the internal rotor A12, as shown in FIG. I.5. In other words: the number of electromagnets A6 is not equal to the number of permanent magnets A7. As a result, the internal rotor A12 rotates more slowly than the magnetic field AF1 by a factor of 7.

Depending on the construction of the motor arrangement A1 and the power outputs to be achieved, the number of electromagnets A6 used and, in relation thereto, the number of permanent magnets A7 used can vary, wherein the number thereof is unequal. An improved energy density and thus power relative to installation space and an improvement in the noise behavior is thereby obtained.

The motor arrangement A1 is suitable especially for use as an actuating drive, in particular an actuating drive for a seat back adjuster or for a rail. The invention can also be used as a separately controlled brake, in particular a wedge brake for a self-locking drive.

FIG. II.1 shows, in a sectional view, an illustrative embodiment of an alternative motor arrangement B1 according to the invention, wherein only the upper motor half above a longitudinal axis BL of the motor arrangement B1 is shown for greater clarity owing to the axial symmetry of the motor arrangement B1.

Parts which correspond to one another in the alternative motor arrangements B1, B1′ to B1^{VIII} described below are provided with the same reference signs.

In particular, the motor arrangement B1 is embodied as an axial planetary-gear motor arrangement and is used, for example, for a seat back adjuster for adjusting a seat back or as a height adjustment motor.

The motor arrangement B1 comprises a stator B2 situated on the outside and a rotor assembly B3 and also a housing B4 surrounding said stator and rotor assembly. In this case, the housing B4 can be of multipart design and, for example, can comprise two housing halves, in particular a bottom and a top. However, it can also comprise more than two housing parts.

The stator B2 is of split design and comprises two stator elements B2.1 and B2.2, between which a wobble element B3.1 and an output-side rotor element B3.2 running on the inside are arranged. The wobble element B3.1 and the rotor element B3.2 are of annular design and are also denoted as a wobble ring and a rotor ring respectively.

The rotor assembly B3 situated on the inside comprises the wobble element B3.1 and the output-side rotor element B3.2, which each have an associated axial tooth system BZ3.1 and BZ3.2 respectively.

In this case, the tooth system BZ3.1 of the wobble element B3.1 is designed as an internal tooth system which faces inward in axial direction BR of the motor arrangement B1 and in which the tooth system BZ3.2 of the rotor element B3.2 engages, which is designed as an external tooth system facing outward in the axial direction BR of the motor arrangement B1.

The motor arrangement B1 comprises a motor shaft B5 (without a pinion output and with positive engagement relative to a transmission rod (not shown)), which carries the rotor assembly B3 and, as shown in FIG. II.1, at least the annular rotor element B3.2. In the region of the motor shaft B5, the rotor element B3.2 is of reinforced design.

Each of the stator elements B2.1, B2.2 once again comprises a number of individual segments, which are each designed as an electromagnet B6. The electromagnets B6 are arranged in an annular manner, and therefore the stator elements B2.1 and B2.2 are also of annular design.

The electromagnets B6 are part of a magnet arrangement for commutating the motor arrangement B1. The electromagnets B6 are arranged on a plate B7 having domes for the electromagnets B6.

For the activation of the electromagnets B6, said electromagnets have windings B6.1, which are connected to an electronic controller B8. Owing to the internal arrangement of the rotor assembly B3 and the external arrangement of the stator B2, the electronic controller B8 is easily accessible from the outside, and therefore direct contacting through the housing B4 is possible. The electronic controller B8 is likewise embodied in the form of a ring.

Contrary to conventional polarity reversal, the electromagnets B6, in particular diagonally opposite electromagnets B6, are simultaneously actuated, i.e. switched on, and thus magnetized and switched off again and thus demagnetized. As a result, the tooth system BZ3.1 of the wobble element B3.1 engages in the tooth system BZ3.2 of the rotor element B3.2 at two diagonally opposite locations or contact zones. This takes place in a revolving manner, with the result that the wobble element B3.1 performs a wobbling motion to the left and right in the axial direction BR and simultaneously rotates.

By virtue of the fact that the tooth systems BZ3.1 and BZ3.2 engage with one another at at least two locations, support for the wobble element B3.1 can be omitted. As shown by way of example in FIG. II.1, the wobble element B3.1 is supported on the housing B4 for torque coupling. For this purpose, the wobble element B3.1 is of u-shaped design in section, wherein the outer end of the annular rotor element B3.2 is arranged between the opposite legs of the wobble element B3.1. The closed bottom of the wobble element B3.1 is designed to curve outward in the direction of the housing B4, and the inner side is embodied in such a way as to curve inward in a manner corresponding thereto, thus allowing the wobble element B3.1 to perform a wobbling motion to the left and right in the axial direction BR.

In this case, the electromagnets B6 and the wobble element B3.1 are arranged in such a way relative to one another that a closed magnetic flux BF in a magnetic field can be generated in at least the magnetized electromagnet B6.

During the operation of the motor arrangement B1, with the magnetization revolving, at least one or preferably a plurality of the electromagnets B6 of both stator elements B2.1 and B2.2 are switched on and off in such a way that diagonally opposite electromagnets 6 of both stator elements B2.1 and B2.2 are magnetized, and directly opposite electromagnets B6 of the respectively other stator element B2.1 or B2.2 are not magnetized. The number of simultaneously magnetizable electromagnets B6 is dependent on the total number of electromagnets B6 of the motor arrangement B1, wherein a plurality of mutually adjacent electromagnets B6 is switched on simultaneously to increase the efficiency and power yield.

The number of teeth in the interengaging tooth systems BZ3.1, B3.2 is different, and therefore a reduction ratio is provided by this difference in the number of teeth in the two meshing gearwheels.

In the illustrative embodiment according to FIG. II.1, the electromagnet B6 of the stator element B2.1 is magnetized, with the result that the wobble element B3.1 is attracted and pivoted in the direction of the stator element B2.1 and the tooth system BZ3.2 of the rotor element B3.2 engages and meshes in the tooth system BZ3.1 of the wobble element B3.1 in the direction of the stator element B2.2. By virtue of the revolving magnetization of individual electromagnets B6, the wobble element B3.1 performs a wobbling motion to the left and right in the axial direction BR.

The motor arrangement B1 having the rotor assembly B3 situated on the inside and the split stator B2 situated on the outside has a single-stage gear with an axial tooth system between the wobble element B3.1 (=wobble ring) and the rotor element B3.2, wherein the axial internal tooth system of the wobble element B3.1 engages and meshes in the axial external tooth system of the rotor element B3.2 at two diagonally opposite locations.

FIG. II.2 shows schematically, in a sectional view, an alternative illustrative embodiment of a motor arrangement BF according to the invention having a rotor assembly B3′ situated on the inside and a split stator B2′ with an axial tooth system between a rotor element B3.2′ and the stator B2′. In other words: an axial tooth system BZ2.1′, BZ2.2′ is integrated into the stator contour. In this case, each stator element B2.1′, B2.2′ has an associated tooth system BZ2.1′, BZ2.2′, which faces inward in the axial direction BR and in which the tooth system BZ3.2′ of the rotor element B3.2′, which is designed as an axial tooth system, engages at at least two locations and meshes in a wobbling manner, with the result that the rotor element B3.2′ itself performs the wobbling motion in the axial direction BR.

As compared with the illustrative embodiment according to FIG. II.1, the wobble element B3.1 is omitted. The rotor element B3.2′ is arranged on the motor shaft B5′ in such a way as to wobble to left and right in the axial direction BR. For rotatable torque coupling of the rotor element B3.2′ on the motor shaft B5′, said shaft has a spherical shape and a longitudinal groove design in the coupling region. For this purpose, the motor shaft B5′ and the rotor element B3.2′ arranged on the motor shaft B5′ are designed to curve in a corresponding manner relative to one another and are provided with longitudinal grooves. This illustrative embodiment is suitable especially for a seat back adjusting drive, also referred to as a recliner drive.

FIG. II.3 shows schematically, in a sectional view, two further illustrative embodiments of a motor arrangement B1′ and B1″ according to the invention having a rotor assembly B3′, B3″ situated on the inside and a split stator B2′ situated on the outside (double/multipart embodiment of the stator) or a simple stator B2″ situated on the outside (single-part embodiment of the stator) with an axial tooth system between a rotor element B3.2′, B3.2″ performing a wobbling motion and the stator B2′, B2″, each having an electronic controller B8′, B8″ arranged on the outside and capable of being contacted directly from the outside.

In this illustrative embodiment, the wobble element B3.1 according to FIG. II.1 is omitted. The rotor element B3.2′, B3.2″ is embodied in such a way as to curve in a manner corresponding to an associated spherical region of the motor shaft B5′, B5″, thus allowing a wobbling motion of the rotor element B3.2′, B3.2″ and spherical torque transfer.

The direct contacting by means of a plug connection B8.1′ through the housing B4′ is illustrated using electronic controller B8′ as an example.

FIGS. II.4A to II.4C show schematically, in an enlarged section, three illustrative embodiments of an alternative motor arrangement B1′″ having an at least partially flexible element B9′″ arranged in the region between the rotor element B3.2′″ and the motor shaft B5′″, with the result that the rotor element B3.2′″ is no longer supported on the motor shaft B5′″. By means of the flexible element B9′″, which is designed to be torsionally stiff in the circumferential direction BZ and to be flexible or deformable in the wobbling or axial direction BR, a wobbling motion of the rotor element B3.2′″ is made possible. In other words: instead of the spherical torque transfer according to FIG. II.3, the torque transfer is here accomplished by means of the flexible element B9′″, which is firmly secured on the pinion B5.1′″ of the motor shaft B5.

FIG. II.4A shows, in an enlarged view, the element B9′″, which is embodied as a thin steel plate or a thin steel diaphragm, in particular as an annular corrugated plate, which is provided with at least one corrugation B9.1′″ and is secured on the pinion B5.1′″ of the motor shaft B5′″. By virtue of the corrugated form, the element B9′″ is torsionally stiff in the circumferential direction BZ and flexible and deformable in the wobbling direction and thus in the axial direction BR and, within limits, toward the center.

In FIG. II.4B, the closed magnetic flux BF via a rotating housing part B4.1′″ is additionally shown. Moreover, the housing B4′″ is of multipart design and comprises housing parts B4.1′″ to B4.3′″. In this arrangement, housing part B4.1′″ is arranged in a fixed manner on a pinion B5.1′″ of the motor shaft B5′″ and rotates relative to housing part B4.2′″ and is supported on housing part B4.2 by means of a bearing B10′″. Housing part B4.2′″ is secured on housing part B4.3′″ by means of a joint B11, e.g. a bolted joint or screwed joint, in order to absorb high radial forces of, for example, 20 N.

In FIG. II.4C, the motor arrangement B1′″ is embodied as an external rotor motor, which is used, in particular, in the presence of relatively low radial forces. For this purpose, one of the housing halves B4.1′″ of the housing B4′″ is firmly connected to the motor shaft B5′″. The rotor element B3.2═″ is likewise connected firmly to the motor shaft B5′″ by means of the element B9′″, which is flexible in the wobbling or axial direction BR. An external tooth system BZ4.1′″ is provided on the outside of housing half B4.1′″. Housing half B4.1′″ is supported by means of a bearing B10, e.g. a roller, ball, plain or friction bearing, on the other housing half B4.2′″, which is secured on housing part B4.3′″ by means of a bolted joint B11.

FIG. II.5 shows schematically, in a sectional view, another illustrative embodiment of a motor arrangement B1^{IV} according to the invention having a rotor assembly B3^{IV} and a simple stator B2^{IV} situated on the outside with a corresponding axial tooth system between the stator B2^{IV} and the rotor assembly B3^{IV}, wherein the axial tooth system interengages only at one location or contact zone owing to the activation of just one of the electromagnets B6. As shown in FIG. II.5, the tooth systems BZ2.1^{IV} and BZ3.2^{IV} engage in one another in the upper motor half, whereas the opposite tooth systems of the annular components are out of engagement.

Since, instead of conventional polarity reversal, the electromagnets B6 are switched on and off and hence fewer eddy currents arise, the coil former can be of solid design. For an optimized, closed magnetic flux BF, the stator B2^{IV} is u-shaped and is designed as a deep-drawn, soft-magnetic plate with extrusion inserts for the magnet windings. As an alternative, the stator B2^{IV} can be designed as a single-part sintered component. It is also possible for the elements to be designed as plastic-encapsulated metal or sheet-metal elements. The element B9^{IV} is connected firmly as an annular corrugated plate, for example, to a pinion B5.1^{IV} of the motor shaft B5^{IV}.

In addition, the motor arrangement B1^{IV} comprises a braking element B12^{IV} as a filler piece, which is designed as a plate and is supported rotatably and in a balanced way on the pinion B5.1^{IV} of the motor shaft B5^{IV}, with the result that, in accordance with the actuation of one of the electromagnets B6, it likewise performs a rotating motion. In particular, the braking element B12^{IV} is designed as a corrugated plate, which has a braking contour B12.1^{IV}. As shown in FIG. II.6A, the braking contour B12.1^{IV} is designed as a u-shaped plate.

The housing part B4.1^{IV} opposite the braking contour B12.1^{IV} has an associated stop contour B13^{IV} on the inside in the region of the braking element B12.1^{IV}. In the magnetized or active state of the electromagnet B2.1^{IV}, the braking element B12^{IV} does not engage in the stop contour B13^{IV} (see FIG. II.6A). When the electromagnet B6 is switched off, the braking contour B12.1^{IV} designed as a stop plate springs back in the direction of the tooth system. The engagement with stop action then takes place automatically during movement/slipping under load.

In the demagnetized state of the electromagnet B2.1^{IV}, the braking element B12^{IV} engages in the stop contour B13^{IV} to stop continued running (see FIG. II.6B). For this purpose, the stop contour B13^{IV} is provided, for example, with a surface structure, e.g. a tooth structure, in particular a sawtooth structure.

The electronic controller B8^{IV} is arranged on the outside of the stator B2^{IV} and is contactable directly from the outside via the plug connection B8.1^{IV}.

FIG. II.7 shows schematically, in a sectional view, another illustrative embodiment of a flexible braking element B12^{V}, which runs with a sliding action along the interior of the housing. The flexible braking element B12^{V} is embodied as a spring element (main corrugated spring), which allows spring back and thus a counterforce without interlocking or a stop action as in the illustrative embodiment according to FIGS. II.6A and II.6B during the running movement.

FIG. II.8 shows schematically, in a sectional view, the illustrative embodiment of the braking element B12^{IV} according to FIGS. II.6A, II.6B, which is out of engagement with a corresponding stop contour B13^{IV} on the inside of the housing (=a filler element or braking/stop element B12^{IV} raised by means of magnetic force). The braking element B12^{IV} is embodied as a filler element and, with the electromagnets B6 alternately switched on and the magnetic fields rotating, follows the active electromagnet B6 by means of tooth engagement and allows a braking and stop function.

The motor arrangement B1^{IV} shown in FIG. II.5 is thus self-adjusting when the electromagnets B6 are active, but, when stationary, the teeth spring back out of engagement, which can lead to damage. To prevent this, the braking element B12^{IV}, which may accompany the movement, is used as a filler body in order to allow the follow-up movement during operation.

Before the start of movement and after actuation of the switch, the integrated electronic controller B8^{IV}, which is embodied as an onboard electronic system, interrogates the position of the rotor assembly B3^{IV} by sequentially checking the coil inductance, wherein the highest value is determined as a tooth engagement.

The determined and correspondingly situated electromagnets B6 are activated, and the braking element B12^{IV} and thus the braking contour B12.1^{IV} are raised, as shown in figure B8, with the result that no coupling and thus no friction with respect to the housing B4^{IV}, e.g. the top, and thus with respect to the stop contour B13^{IV} occurs.

As the active electromagnets B6 revolve, the filler body or the braking element B12^{IV} follows owing to magnetic attraction and slides along the rotor element B3.2^{IV} (=toothed ring of rotor assembly) (special measures for optimum sliding).

To stop the motor motion, the filler body or the braking element B12^{IV} is lowered again by deactivating or switching off the electromagnet B6.

FIG. II.9 shows schematically, in a sectional view, the illustrative embodiment of the braking element B12^{V} according to FIG. II.7, which is displaced with a sliding action along the interior of the housing, wherein the mechanism of attraction and raising of the braking element B12^{V} by/from the rotor element B13^{V} and that of releasing and lowering the braking element B12^{V} onto the rotor element B13^{V} take place in a manner similar to that described under FIG. II.8 with reference to braking element B12^{IV}.

FIG. II.10 shows schematically, in a sectional view, another illustrative embodiment of a motor arrangement B1^{VI} according to the invention having a rotor assembly B3^{VI} and a simple stator B2^{VI} situated on the outside with an axial tooth system between a wobble element B3.1^{VI} and a rotor element B3.2^{VI} only at one location (=contact zone) and having an electronic controller B8^{VI}, which is arranged on the outside and is contactable directly from the outside. For greater efficiency, the stator B2^{VI} is of u-shaped design. The tooth systems BZ3.1^{VI} and BZ3.2^{VI} of the wobble element B3.1^{VI} and of the rotor element B3.2^{VI} are arranged between the two legs of the stator B2^{VI} and opposite the electromagnet B6, with the result that two closed circuits are formed for the magnetic flux BF on the one contact zone or intermeshing location.

For torque transfer, the wobble element B3.1^{VI} is supported on the housing B4^{VI} in a sliding manner or, alternatively, by means of balls for reduced friction, and is guided on the motor shaft B5^{VI} by means of a ball guide (no torque transfer). As an alternative, the wobble element B3.1^{VI} can be supported on the motor shaft B5^{VI} by means of a ball bearing assembly or rolling friction. On the inside, the motor shaft B5^{VI} has a longitudinal groove design for the positive attachment of a transmission rod (not shown).

To absorb and support axial forces occurring due to the wobbling motion, the housing B4^{VI} has a reinforcement BV.

The motor arrangement B1^{VI} shown in FIG. II.10 has optimized tolerance ratios of the two tooth systems BZ3.1^{VI} and BZ3.2^{VI} to one another and to the overall arrangement.

FIG. II.11 shows schematically, in a sectional view, an illustrative embodiment for a rotor element B3.2′ to B3^{VI} of rigid design.

FIG. II.12 shows schematically, in a sectional view, an alternative illustrative embodiment of a rotor element B3.2^{VII} of flexible design, which is of elastically deformable design, at least in the center. As compared with the rigid rotor element B3.2′ to B3.2^{VI} having an active contact zone (=tooth engagement), the energy density and power output is increased in the case of the rotor element B3.2^{VII} of flexible design.

Moreover, it is also possible to achieve two contact zones with the aid of the flexible, elastic rotor element B3.2^{VII}.

The rotor element B3.2^{VII} of flexible design requires a tooth system matched to the deflection curve and has a suitable deformability. In the case of two contact zones or locations and an even tooth number ratio, a 2-tooth difference is obtained after one wobbling revolution.

In an illustrative embodiment having a rotor element B3.2^{VII} of flexible design with two contact zones, the above-described braking element B12^{VII} is accordingly provided with two opposite functional arms.

FIG. II.13 shows schematically, in plan view, an illustrative embodiment of a rotor element B3.2^{VIII} of annular and flexible design having a plurality of individual segments B3.2n without an external tooth contour. The connection BV between the individual segments B3.2n can be made by means of resistance welding or laser welding.

The respective individual segment B3.2n is embodied as a sintered component or extruded component. As an alternative, it can be designed as a deep-drawn, soft-magnetic plate with extrusion inserts for the windings B6.1^{VIII} with or without a tooth contour already in the metal main body.

FIGS. II.14 and II.15 show schematically, in section and in perspective view, an individual segment B3.2n having adjoining flexible zones Z (compensation zones) between the individual segments B3.2n. Moreover, the external tooth contour of the metal main body BG can be overmolded with plastic BK.

FIG. II.16 shows schematically, in a sectional view, an illustrative embodiment of an alternative braking element B12, which is designed as an integrated actuator B14.

The above-described braking plate must be able to follow the wobbling motion without blocking the motor and hence the motor arrangement B1 through unwanted contact. FIG. II.16 shows an alternative to this: the controller ensures that the rotor element B3.2 can stop only in one position (this being sufficiently accurate and also being capable of being secured by capacitors, for example, in the case of a power failure). Opposite said position, the electromagnet B6 is replaced by an actuator B14 which, then being deenergized, presses the rotor element B3.2 by means of a spring-loaded pin, peg or stud B14.1 against the housing B4, e.g. a top wall, where, for example, a tooth system or some other suitable stop contour, in particular a tooth contour with a braking contour, comes into engagement. Just before and during operation, the electromagnet B6 or some other magnet ensures that the stud B14.1 moves back.

As an option, in an embodiment which is not shown, a double magnet can be provided for smooth running, wherein a hole for a peg and, axially behind the latter, a magnet for the peg are provided on the rotor assembly (similarly to the stud in the electromagnet, as described above).

A brake embodiment of this kind having an integrated actuator B14 is suitable for supporting crash loads since the forces are distributed between the tooth system and the “short circuit” (contact zone) to the housing B4.

FIG. II.17B shows schematically, in a sectional view, another illustrative embodiment of a braking element B12, which is designed as an alternative tooth system contour with partial clearance cuts.

As shown in FIGS. II.11 and II.17A, and described with reference thereto, switching of the current of the magnetized electromagnet B6 causes the rotor ring or element B3.2 to spring back in direction BRF, with the result that the latter, in particular the tooth system BZ3.2 thereof, disengages. As a result, there can be tooth tip contact and damage at the circumference of more remote regions BB. This can be prevented by partial clearance-cutting of said regions BB (more surface area in engagement). This stable position which is then reached can also be used to prevent slipping (without extra components). Here, slight friction of the tooth tips for simple braking can be accepted. Moreover, the friction which occurs when the tooth tips touch after springback can be used to produce desired friction at this location or to form a positive lock.

Another alternative motor arrangement C1 is described below.

The invention according to FIGS. III.1 to III.12B serves to allow improved functions and various applications in the switched-off state of a motor arrangement C1, shown in FIG. III.1, after the switching off of the current and thus in non-operating mode, e.g.:

1. Obtaining tooth engagement without backlash or allowing decoupling (e.g. in a bicycle drive),
2. Preventing slipping (=anti-slip brake when driving non-self-locking mechanisms with load flow via a wobble rotor, e.g. a corrugated plate) and/or
3. The ability to absorb crash loads better (crash lock for drives exposed to direct crash loads, e.g. in the case of housing/screwed joint to output).

FIG. III.1 shows, in an exploded view, an illustrative embodiment of a motor arrangement C1 according to the invention having a motor unit C1a, which is surrounded by a multi-part housing having two housing parts C4a, C4b. Here, the housing can be of multi-part design and can comprise a bottom and a top, for example. However, it is also possible for it to comprise more than two housing parts.

In particular, the motor arrangement C1 is embodied as an axial planetary-gear motor arrangement and is used as a drive for a seat back adjuster for adjusting a seat back or as a drive for a height adjuster, for example. Owing to the modular construction, the motor arrangement C1 can also be used as a bicycle drive or as a drive for a longitudinal adjuster through appropriately selected embodiment of the brake unit C1b.

The motor arrangement C1 comprises a stator C2 situated on the outside and a rotor assembly C3.

The stator C2 is of split design and comprises a stator ring C2.1 and a magnet arrangement C2.2, in particular a magnet ring having a number of individual segments C5, comprising a corresponding number of electromagnets C6 having coil windings C6.1 (=solenoids). The individual segments C5 and thus the electromagnets C6 are arranged in an annular manner. The electromagnets C6 are part of the magnet arrangement C2.2 for commutating the motor arrangement C1. In this case, the respective electromagnet C6 can be designed as a simple electromagnet with an encircling winding.

As an alternative, the electromagnet can be provided, as a double electromagnet, with two magnet halves and two encircling windings, wherein only one of the magnet halves is magnetizable. Depending on the construction of the motor arrangement C1 and the power levels to be achieved, the number of electromagnets C6 used can vary. Improved energy density and an improvement in noise behavior are thereby obtained.

Moreover, the stator C2 comprises a toothed stator ring C2.3 having an axial tooth system CZ2.4 facing in the direction of the rotor assembly C3.

The rotor assembly C3, which is situated on the inside, comprises a rotor element C3.1 (also referred to as a wobble element or wobble ring or rotor ring), in particular an annular rotor element. The output-side rotor element C3.1 has an axial tooth system CZ3.3 facing in the direction of the stator C2.

The motor arrangement C1 comprises the output shaft C3.2 (a motor shaft without a pinion output and with positive engagement with a transmission rod (not shown)), which carries the rotor assembly C3 and, as shown in figure C1, at least the annular rotor element C3.1.

For the activation of the electromagnets C6, these have the coil windings C6.1, which are connected to an electronic controller C7 (in a manner not shown). The electronic controller C7 is integrated in the stator C2 and is arranged between the stator ring C2.1 and the housing part C4a. Owing to the external arrangement of the stator C2, the electronic controller C7 is easily accessible from the outside, and therefore direct contacting through the housing part C4a is possible. The electronic controller C7 is likewise of annular design.

During the operation of the motor arrangement C1 having a single-stage gear, the electromagnets C6 are actuated individually in a revolving manner. As a result, the axial tooth system CZ3.3 of the rotor element C3.1 engages and meshes in the axial tooth system CZ2.4 of the toothed stator ring C2.3 at one location or contact zone, whereas the tooth systems at the opposite location are out of engagement. This takes place in a revolving manner, with the result that the rotor element C3.1 performs a wobbling motion about a revolving axis sloping relative to the longitudinal axis CL.

In the case of an alternative motor arrangement (not shown specifically) having a two-stage gear, the electromagnets, in particular electromagnets situated diagonally opposite one another, are simultaneously actuated, i.e. switched on, and thus magnetized and are switched off again and thus demagnetized. As a result, the tooth system of the rotor element engages in the tooth system of the toothed stator ring at two diagonally opposite locations or contact zones. This takes place in a revolving manner, with the result that the rotor assembly in this embodiment performs a pure rotary motion about the axis, while elastically deformable tooth regions of the stator element or toothed stator ring C2.3 perform a substantially axial oscillation in the axial direction of the longitudinal axis CL.

In the region between the rotor element C3.1 and the output shaft C3.2, at least one partially flexible element C8 is arranged, with the result that the rotor element C3.1 is no longer supported on the output shaft C3.2. The flexible element C8 is designed, for example, as a corrugated plate having a corrugation C8.1 projecting in the direction of the rotor element C3.1 in the axial direction CR. By means of the flexible element C8, which is of torsionally stiff design in the circumferential direction CZ and of compliant or deformable design in the axial direction CR, a rotary motion of the rotor element C3.1 is made possible. Here, torque transfer takes place via the flexible element C8, which is secured on the pinion C3.4 of the output shaft C3.2.

The electromagnets C6 and the rotor element C3.1 are arranged relative to one another in such a way that a closed magnetic flux CF in a magnetic field can be generated in at least the magnetized electromagnet C6.

During the operation of the motor arrangement C1, at least one or preferably more of the electromagnets C6 of the magnet arrangement C2.2 are switched on and off in such a way when there is revolving magnetization that, of two diagonally opposite electromagnets C6 of the magnet arrangement C2.2, one is magnetized and the directly opposite one is not magnetized. Since, instead of conventional polarity reversal, the electromagnets C6 are switched on and off and hence fewer eddy currents arise, the coil former can be of solid design.

For an optimized closed magnetic flux, the stator ring C2.1 is embodied as a double ring having a u-shaped longitudinal or axial cross section. The stator ring C2.1 can be designed as a deep-drawn, soft-magnetic plate with extrusion inserts for the magnet windings.

The number of electromagnets C6 which can be magnetized simultaneously is dependent on the total number of electromagnets C6 of the motor arrangement C1, wherein a plurality of mutually adjacent electromagnets C6 is switched on simultaneously to increase the efficiency and power yield.

The number of teeth in the interengaging axial tooth systems CZ3.3, C2.4 is different, and therefore a reduction ratio of, for example, 1:95 is provided by this difference in the number of teeth in the two meshing gearwheels.

To meet one or more of the requirements presented above at the outset, the motor arrangement C1 is of modular construction, comprising a motor unit C1a and, optionally, a braking unit C1b, which is illustrated in FIG. III.2.

FIG. III.2 shows schematically, in an exploded view, another embodiment of a motor arrangement C1′ having the module comprising the motor unit C1a and the module comprising the braking unit C1B with a simple anti-slip braking function without overload safeguard (crash lock) for improved functioning after the current is switched off and thus in the switched-off state of the motor arrangement C1′.

In other words: the motor arrangement C1′ according to FIG. III.2 additionally comprises the braking unit C1b having a braking element C9. The braking element C9 is a pawl, which is designed as a rocker having at least one braking stud C9.1. The braking element C9 is supported on the housing C4a and/or C4b in such a way as to be pivotable about a pivot C9.2. Moreover, the stator ring C2.1 furthermore has two axially projecting extensions C2.5′, C2.5″ as magnetic field extensions on the outer radial edge in the direction of the braking element C9, so that, given appropriate actuation of one of the electromagnets C6, in the example actuation of electromagnet C6′ or C6″, there is an interaction with the braking element C9. During this process, the braking element C9 performs a pivoting motion in the direction of extension C2.5′ or C2.5″, as a result of which the braking stud C9.1 comes into braking engagement with an encircling braking rib C3.5 arranged on the facing surface side of the rotor element C3.1 (with electromagnet C6″ switched on and pivoting in the direction of extension C2.5″) or moves out of engagement with said rib (with electromagnet C6′ switched on and pivoting in the direction of extension C2.5′).

The braking element C9 serves as an anti-slip brake, which can be coupled without backlash. For this purpose, the electronic controller C7 (not shown in FIG. III.2) comprises a flip-flop control system for the braking element C9, thereby assisting the rocking and pivoting function during anti-slip braking Here, control takes the form of stable end-position control without intermediate positions. This means that, after a brief activation of electromagnet C6″—and also if the current is then switched off—braking in the case of movement/slipping under load is automatic.

In addition, the rotor element C3.1 in the illustrative embodiment according to FIG. III.2 comprises a number of supporting pins C10, which can be arranged and thus supported in corresponding grooves C11 in the output shaft C3.2. For this purpose, the output shaft C3.2 has a radial extension C12, which is provided on the edge with the corresponding grooves C11. In the illustrative embodiment according to FIG. III.2, three supporting pins C10 are provided, which are arranged in a symmetrically distributed manner and can be arranged with play/clearance on the output shaft C3.2, ensuring that normally the flexible element C8 assumes the task of power transmission. An overload safeguard is enabled only indirectly via the control of the braking element C9 by a pin interlock by means of the supporting pin C10.

FIGS. III.3A and III.3B show the motor arrangement C1′ in plan view in a locked position and thus with electromagnet C6″ switched on and braking element C9 pivoted in the direction of extension C2.5″, with the result that an anti-slip braking function is provided by the braking stud C9.1 running along the braking rib C3.5 and tooth engagement of the axial tooth systems CZ2.4 and CZ3.3 is ensured, even without power. In this case, tooth engagement at just one location or position on the circumference is sufficient and precise as well as easy to implement. A motor arrangement C1′ of this kind is suitable especially for a rotary seatback adjuster.

FIGS. III.4A and III.4B show the motor arrangement C1′ in plan view in a running position and thus with electromagnet C6′ switched on and braking element C9 pivoted in the direction of extension C2.5′, with the result that the braking stud C9.1 moves out of engagement with the braking rib C3.5 and the axial tooth systems CZ2.4 and CZ3.3 move out of engagement and are thus released.

FIG. III.5 shows FIGS. III.3A and III.4B superimposed and the slightly different position of the rotor assembly.

FIGS. III.6A to III.6B shows schematically an alternative embodiment of a motor arrangement C1″ in plan view with a braking unit C1b without an anti-slip braking function and with an alternative direct overload safeguard (crash lock).

A motor arrangement C1″ of this kind is suitable particularly for a wobble-type seatback adjuster, in which there are non-self-locking mechanisms which are to be fixed by the drive and thus locked.

There are various alternatives for this purpose:
the residual torque of the motor arrangement C1″ and thus of the drive is sufficient as a braking torque in order to prevent slipping as a whole,
readjustment by short, pulsed switching on of the drive. By interrogation of the inductivity of the coil windings C6.1, it is possible to determine the position of the rotor element C3.1. Slipping takes place only while the vehicle is being driven and can be compensated in a precise way by means of the electronic controller C7,
mechanical retention devices, e.g. stud or pawl locks.

In FIGS. III.6A to III.11, the motor arrangements C1″ to C1^{V} shown have braking units C1b of different kinds with different braking functions.

FIGS. III.6A and III.6B show a braking unit C1b having an alternative braking element C9′, which, instead of the braking stud C9.1 and the braking rib C3.5 according to FIG. III.2, has a tooth-type pawl C9.3, which engages with a stopping and thus locking action in a corresponding locking element C13 when electromagnet C6″ is switched on. This braking unit C1b allows continuous tooth engagement of the axial tooth systems CZ3.3 and CZ2.4 and a crash lock without an anti-slip brake after the power is switched off.

Here, FIG. III.6A shows the motor arrangement C1″ in plan view in a locked position and thus with the electromagnet 6″ switched on and the braking element C9′ pivoted in the direction of extension C2.5″, with the result that a crash lock and tooth engagement of the axial tooth systems CZ2.4 and CZ3.3 is ensured, even without power.

FIG. III.6B shows the motor arrangement C1″ in plan view with electromagnet C6′ switched on and braking element C9′ pivoted in the direction of extension C2.5′, with the result that the crash lock is open and the motor arrangement C1″ is in a running position.

A motor arrangement C1″ of this kind is suitable particularly for a rotary wobble-type seatback adjuster.

FIGS. III.7A to III.9B show schematically another alternative embodiment of a motor arrangement C1′″ in plan view with a braking unit C1b with an anti-slip braking function and with an alternative overload safeguard (crash lock). For the anti-slip braking function, the braking unit C1b comprises the braking element C9 with braking stud C9.1 and the corresponding projecting and encircling braking rib C3.5 on the rotor element C3.1. In addition, the braking unit C1b comprises an alternative locking element C13′ with an external tooth system designed to correspond to the braking stud C9.1, the braking stud C9.1 serving both for the anti-slip braking function and as an overload safeguard. In this embodiment, the motor arrangement C1′″ comprises two annular guide plates C14, which are spaced apart and which are provided with corresponding recesses C15, e.g. arc-shaped groove C15.1, slots C15.2, for the braking stud C9.1 and the extensions C2.5′ and C2.5″.

FIGS. III.7A and III.7B show the motor arrangement C1′″ in plan view in the locked position and thus with electromagnet C6″ switched on and braking element C9″ pivoted in the direction of extension C2.5″, with the result that an anti-slip braking function is provided by the running of the braking stud 9.1 along the braking rib C3.5 and tooth engagement of the axial tooth systems CZ2.4 and CZ3.3 is ensured, even without power.

FIG. III.8 shows a sectional view of the motor arrangement C1′″ in the locked position, where only the upper motor half above a longitudinal axis CL of the motor arrangement C1 is shown owing to the axial symmetry of the motor arrangement C1′″ and for greater clarity.

FIGS. III.9A and III.9B show the motor arrangement C1′″ in plan view in a running position and thus with electromagnet C6′ switched on and braking element C9″ pivoted in the direction of extension C2.5′, with the result that the braking stud C9.1 moves out of engagement with the braking rib C3.5 and the axial tooth systems CZ2.4 and CZ3.3 also move out of engagement and are thus released.

FIGS. III.10A to III.10B show schematically another alternative embodiment of a motor arrangement C1^{IV} in plan view with a braking unit C1b having an alternative, in particular weaker, anti-slip braking function than the anti-slip braking functions already described and without an overload safeguard (crash lock).

In this embodiment, the braking element C9, C9′ or C9″ is omitted. In this embodiment, the braking unit C1b is integrated in the stator C2. For this purpose, permanent magnets C16 are arranged in the magnet arrangement C2.2, in particular in the coil winding C6.1 (also referred to as a coil former in the case of solid design), said permanent magnets being axially movable in the axial passage C17 provided for this purpose.

During the operation of the motor arrangement C1^{IV}, the permanent magnet C16 of the respective individual segment is held by the applied current in the direction of the stator ring C2.1 and thus on the steel magnetic field former.

When the voltage and thus the current is switched off, the polarity of the relevant electromagnet C6 is briefly reversed, with the result that the permanent magnet C16 is moved axially in the direction of the rotor element C3.1 in the passage C17, as far as the stop, with the result that the stator C2, in particular the axial tooth system CZ2.4 thereof, remains in engagement. This causes a slight braking effect, which is sufficient to prevent slipping.

Depending on the desired braking effect or application, one, two or more permanent magnets C16 can be provided. As an alternative or in addition, the permanent magnet or magnets C16 can be provided with a predetermined cross section or predetermined outer contour in order to achieve an anti-rotation safeguard or significantly higher forces of attraction. For example, the permanent magnet or magnets C16 can have a negative tooth contour in order to come into closer contact with the rotor assembly C3.

FIGS. III.11 to III.12B show schematically another alternative embodiment of a simple motor arrangement C1^{V} in longitudinal section and in an exploded view with a braking unit C1b without an anti-slip braking function and without an overload safeguard (crash lock) and a simple stator C2′ without a U shape owing to direct magnetic flux.

In motor arrangement C1^{V}, the stator ring C2.1 is omitted. Motor arrangement C1^{V} comprises an alternative toothed stator ring C2.3′ as a stator C2′ and an alternative magnet arrangement C2.2′. On the surface side facing away from the axial tooth system CZ2.4, the toothed stator ring C2.3′ has a number of depressions C17.1, into which at least one of the stud-shaped extensions C18 of the electromagnets C6 of the magnet arrangement C2.2′ engages in one of the corresponding depressions C17.1 in the toothed stator ring C2.3′, given appropriate control by means of the electronic controller C7.

Owing to the axial symmetry of the motor arrangement C1^{V} and for greater clarity, FIG. III.11 shows only the upper motor half above a longitudinal axis CL of the motor arrangement C1^{V}, with an extension C18 engaging in the associated depressions C17.1. Accordingly, the diagonally opposite extension C18 (not shown) of the electromagnet C6 would be out of engagement.

The rotor assembly C3 with the output shaft C3.2, in which a through rod (not shown) engages, is supported in the stator C2′ by means of a plain bearing C19. The magnet arrangement C2.2′ is held in the housing, offers installation space in its interior for parts C20 of the electronic controller C7 and comprises a retention plate C21, on which the individual segments C5 are arranged in an annular manner.

FIGS. III.12A and III.12B show the motor arrangement C1^{V} according to FIG. III.11 in an exploded view slightly at an angle from the front and the rear respectively. During the operation of the motor arrangement C1^{V} with the single-stage gear shown, the electromagnets C6 are actuated individually in a revolving manner. As a result, the axial tooth system CZ2.4 of the toothed stator ring C2.3 engages and meshes in the axial tooth system CZ3.3 of the rotor element C3.1 at one location or contact zone, whereas the tooth systems at the opposite location are out of engagement. This takes place in a revolving manner, with the result that the toothed stator ring C2.3 performs a wobbling motion to the left and right in the axial direction CR. In other words: there is direct power transmission by means of the stud-shaped extensions C18, which permit the spatial wobbling motion of the toothed stator ring C2.3 but prevent the rotation thereof about the axis CR and thus ensure torque support relative to the housing.

After the power has been switched off and thus while the motor arrangement C1^{V} is not in operation, the axial tooth systems CZ2.4 and CZ3.3 can continue to remain in engagement at at least one position or contact location by switching on one of the electromagnets C6.

This motor arrangement C1^{V} does not have an anti-slip brake or crash lock and is suitable, in particular, for a rotary seat back adjuster.

The motor arrangements C1 to C1^{V} described are of modular construction and, depending on the application, have an appropriately designed motor unit C1a and/or an appropriately designed braking unit C1b, which can be coupled to one another, thus allowing various driving functions and/or braking functions. Moreover, these motor arrangements C1 to C1^{V} can be individualized by adaptation of the integrated electronic controller C7.

While specific embodiments of the invention have been shown and described in detail to illustrate the application of the principles of the invention, it will be understood that the invention may be embodied otherwise without departing from such principles.

### LIST OF REFERENCE SIGNS

A1 motor arrangement

A2 stator

A3 rotor assembly

A4 housing

A5 magnet arrangement

A6 electromagnet

A6.1 magnet halves

A6.2 windings

A7 permanent magnet

A8 wobble bearing

A9 motor shaft

A10 output-side external rotor

A10.1 external tooth system

A11 input-side external rotor

A11.1 external tooth system

A12 internal rotor

A12.1 external tooth system

A12.2 inner side

A12.3 leg

A13 shaft bearing

A14 active region

A15 air gap

AF1 magnetic flux

AR magnetization direction

B1′ . . . B1^{VIII} motor arrangement

B2′ . . . B2^{VIII} stator

B2.1, B2.2 . . . B2.1′, B2.2^{VIII} stator elements

B3′ . . . B3^{VIII} rotor assembly

B3.1′, B3.1^{VI} wobble element

B3.2′ . . . B3.2^{VIII} rotor element

B4′ . . . B4^{VIII} housing

B4.1′ . . . B4.3′, . . . , B4.1^{VIII} . . . B4.3^{VIII} housing parts

B5′ . . . B5^{VIII} motor shaft

B6′ . . . B6^{VIII} electromagnet

B7′ . . . B7^{VIII} plate

B8′ . . . B8^{VIII} electronic controller

B8.1′ . . . B8.1^{VIII} plug connection

B9′″ element

B10′″ bearing

B11′″ connection

B12^{IV} . . . B12^{VIII} braking element

B12.1^{IV} . . . B12.1^{VIII} braking contour

B13^{IV} . . . B13^{VIII} stop contour

B14 actuator

B14.1 stud

BB ranges

BF magnetic flux

BG metal main body

BK plastic

BL longitudinal axis

BR axial direction

BRF direction of spring back

BV connection

BZ zone

BZ3.1, Z3.2 tooth system

BZ4.1′″ external tooth system

C1 to C1^{V} motor arrangement

C1a motor unit

C1b braking unit

C2 to C2′ stator

C2.1 stator ring

C2.2 electromagnet arrangement

C2.3 toothed stator ring

CZ2.4 axial tooth system of the toothed stator ring

C2.5′, C2.5″ axial extension of the stator ring

C3 rotor assembly

C3.1 rotor element

C3.2 output shaft

CZ3.3 axial tooth system of the rotor element

C3.4 pinion

C3.5 braking rib

C4a, C4b housing parts

C5 individual segments

C6, C6′, C6″ electromagnet

C6.1 coil winding

C7 electronic controller

C8 flexible element, corrugated plate

C8.1 corrugation

C9, C9′, C9″ braking element

C9.1 braking stud

C9.2 pivot

C9.3 tooth-type pawl

C10 supporting pin

C11 grooves

C12 radial extension

C13, C13′ locking element

C14 guide plates

C15 recesses

C15.1 arc-shaped groove

C15.2 slot

C16 permanent magnet

C17 passage

C17.1 depression

C18 extension of the electromagnet

C19 plain bearing

C20 guide rings

C21 retention plate

CF closed magnetic flux

CL longitudinal axis

CR axial direction

1. A motor arrangement, in particular a planetary gear motor arrangement, comprising:
a stator and a rotor assembly and a housing surrounding said stator and rotor assembly, wherein the stator is formed from a magnet arrangement, which has a number of electromagnets, which are arranged in an annular manner, and a number of permanent magnets which is not equal to the number of electromagnets, said electromagnets and permanent magnets being arranged in relation to one another in such a way that a closed magnetic flux with an axial magnetization direction can be generated in a magnetic field in at least one of the electromagnets, wherein an internal rotor or toothed ring, which is provided with an axial external tooth system, as part of the stator, meshes in at least one axial external tooth system of the rotor assembly.

2. The motor arrangement as claimed in claim 1, wherein the internal rotor is designed in such a way that the internal rotor meshes at at least two locations on the rotor assembly.

3. The motor arrangement as claimed in claim 1, wherein the internal rotor is provided with two axial external tooth systems, which are spaced apart and teeth of which face away from one another.

4. The motor arrangement as claimed in claim 1, wherein the rotor assembly comprises two external rotors, which are spaced apart and which are provided on a mutually facing surface side with associated axial external tooth systems.

5. The motor arrangement as claimed in claim 1, wherein the internal rotor has a U shape in cross section, wherein legs of the internal rotor are oriented radially outward and the electromagnets are arranged in a space between the legs, wherein an axial external tooth system is arranged on an outside of each of said legs.

6. A motor arrangement, in particular a planetary-gear motor arrangement, comprising:
a motor shaft;
a stator, and a rotor assembly, and a housing surrounding said stator and rotor assembly, wherein the stator is formed from a magnet arrangement, which has a number of electromagnets arranged in an annular manner, and at least one permanent magnet, which are arranged relative to one another in such a way that a closed magnetic flux with an axial magnetization direction in a magnetic field can be generated in at least one of the electromagnets, wherein the motor arrangement is designed with a single-stage gear in such a way that the stator provided with an axial external tooth system or a wobble element meshes in at least one axial external tooth system of the rotor assembly, wherein at least one of:
an at least partially flexible element is arranged on a pinion between the rotor assembly (B3′ to B3^{VIII}) and the motor shaft, and
a braking element is arranged on a pinion, between the rotor assembly and the motor shaft.

7. The motor arrangement as claimed in claim 6, wherein the flexible element is designed in such a way that the flexible element is torsionally stiff in a circumferential direction and deformable in an axial direction.

8. The motor arrangement as claimed in claim 6, wherein the flexible element is designed as a thin steel plate or a thin steel diaphragm or a corrugated plate.

9. The motor arrangement as claimed in claim 6, wherein the braking element is designed as one of a filler piece and a corrugated plate, which is arranged rotatably on the pinion.

10. The motor arrangement as claimed in claim 6, wherein the wobble element is provided between at least one stator element and a rotor element, wherein the wobble element has at least two tooth systems, which mesh in external tooth systems of the rotor element.

11. A motor arrangement, in particular a planetary-gear motor arrangement, comprising:
a motor unit having a stator, a rotor assembly, an at least single-stage gear with an axial tooth system between the stator and the rotor assembly, and an integrated electronic controller, and
a braking unit at least for braking against slipping of the motor unit, wherein the motor unit and the braking unit are formed separately and can be coupled to one another.

12. The motor arrangement as claimed in claim 11, wherein the motor unit and the braking unit are each of modular design, wherein the motor unit and the braking unit are each adapted individually to at least one of predetermined motor requirements and braking functions and constructed accordingly.

13. The motor arrangement as claimed in claim 11, wherein the motor unit is designed as a module comprising the stator, the rotor assembly, the integrated electronic controller and with a single- or two-stage gear.

14. The motor arrangement as claimed in claim 11, wherein the braking unit is designed as a module having at least one braking function.

15. The motor arrangement as claimed in claim 11, wherein the braking unit is embodied in an at least partially integrated way, wherein at least one component is part of the motor unit.

16. The motor arrangement as claimed in claim 1, wherein the internal rotor is designed in such a way that the internal rotor meshes at at least two diagonally opposite locations on the rotor assembly.

17. The motor arrangement as claimed in claim 6, wherein said stator is situated on an outside, and said rotor assembly is situated on an inside.

18. The motor arrangement as claimed in claim 11, wherein the braking unit is designed as a module having at least one braking function with one or more of a tooth engagement function, an anti-slip braking function and a locking function.
